(19) United States
(12) Patent Application Publication
(10) Pub. No.: US 2013/0318155 A1
(43) Pub. Date: Nov. 28, 2013

(54) INFORMATION PROCESSING APPARATUS, NETWORK SYSTEM AND INFORMATION PROCESSING METHOD

(71) Applicant: BUFFALO INC., Nagoya-shi (JP)

(72) Inventor: Goki ICHIKAWA, Nagoya-shi (JP)

(21) Appl. No.: 13/900,198

(22) Filed: May 22, 2013

(30) Foreign Application Priority Data
May 24, 2012 (JP) 2012-118846
Jan. 31, 2013 (JP) 2013-16777

(51) Int. Cl. H04L 29/08

(52) U.S. Cl. CPC H04L 67/02
USPC 709/203

(57) ABSTRACT

An information processing apparatus includes processing circuitry that is configured to implement a WEB page browser configured to serve as a WEB browser, an individual functioner configured to process information, and a server functioner configured to cause shared data to be transferred to and from the WEB page browser according to a data transfer protocol. The WEB page browser and the individual functioner share the shared data therebetween.

### CROSS-REFERENCE TO RELATED APPLICATIONS

This application claims priority to Japanese Patent Application No. 2012-118846 filed on May 24, 2012 and Japanese Patent Application No. 2013-16777 filed on Jan. 31, 2013, which are hereby incorporated by reference in their entireties and for all purposes.

### TECHNICAL FIELD

The invention relates to an information processing apparatus.

### BACKGROUND ART

The most distinctive feature of currently popular HTTP (HyperText Transfer Protocol) is conclusion of processing by only one cycle of “a request from a client device” and “a response from a server device”, i.e., stateless. The stateless protocol such as HTTP does not require the server device to manage the record of past transmissions with the respective client devices. This reduces the load of the server device, so that one single server device supporting HTTP can simultaneously provide a large number of client devices with services.

In communication between the client device and the server device according to HTTP, there has been a requirement for the server device to manage information on the client device over a plurality of communication sessions without using a cookie that is supposed to have security vulnerability. According to one proposed technique to meet this requirement, the server device receives a requirement including a client identifier from the client device and gains access to a database in response to the reception of the client identifier, so as to manage the status information of the client device over a plurality of communication sessions (for example, JP 2004-280828A).

### SUMMARY

There is a requirement to manage information involved in a plurality of different processes performed between a WEB browser used to browse a content obtained according to HTTP and a predetermined function program within a single client device, instead of between the client device and the server device.

Such requirement is not limited to the client device but is the common requirement for various information processing apparatuses including a server device that provides the client device with services and a network relay apparatus that relays information in a network. Such requirement is also not limited to HTTP but is the common requirement for various data transfer protocols that enable data transmission between the client device and the server device, such as HTTPS (HyperText Transfer Protocol Secure) and FTP (File Transfer Protocol).

According to one aspect of the disclosure, there is provided an information processing apparatus. The information processing apparatus includes processing circuitry configured to implement a WEB page browser configured to serve as a WEB browser, an individual functioner configured to process information, and a server functioner configured to cause shared data to be transferred to and from the WEB page browser according to a data transfer protocol, wherein the WEB page browser and the individual functioner are configured to share the shared data.

The disclosure may be implemented by any of various applications, for example, an information processing apparatus, a network system, an information processing method, a computer program configured to implement the functions of any of such apparatus, system and method, and a non-transitory, computer-readable storage medium in which such a computer program is recorded.

### BRIEF DESCRIPTION OF DRAWINGS

FIG. 1 is a diagram illustrating the general configuration of a network system using an information processing apparatus according to one embodiment of the disclosure;

FIG. 2 is a sequence diagram showing the procedure of a communication setup process;

FIG. 3 is a diagram illustrating a data sharing method between a WEB browser and a configuration application;

FIG. 4 is a diagram illustrating the general configuration of a network system using an information processing apparatus according to a second embodiment;

FIG. 5 is a sequence diagram showing the procedure of the communication setup process according to the second embodiment;

FIG. 6 is a diagram illustrating a data sharing method between a WEB browser and a configuration application according to the second embodiment;

FIG. 7 is a diagram illustrating the general configuration of a network system using an information processing apparatus according to a third embodiment;

FIG. 8 is a sequence diagram showing the procedure of a service starting process;

FIG. 9 is a diagram illustrating the general configuration of a network system using an information processing apparatus according to a fourth embodiment; and

FIG. 10 is a diagram illustrating the general configuration of a network system using an information processing apparatus according to a fifth embodiment.

### DESCRIPTION OF EMBODIMENTS

### A. First Embodiment

### A-1. General Configuration of System

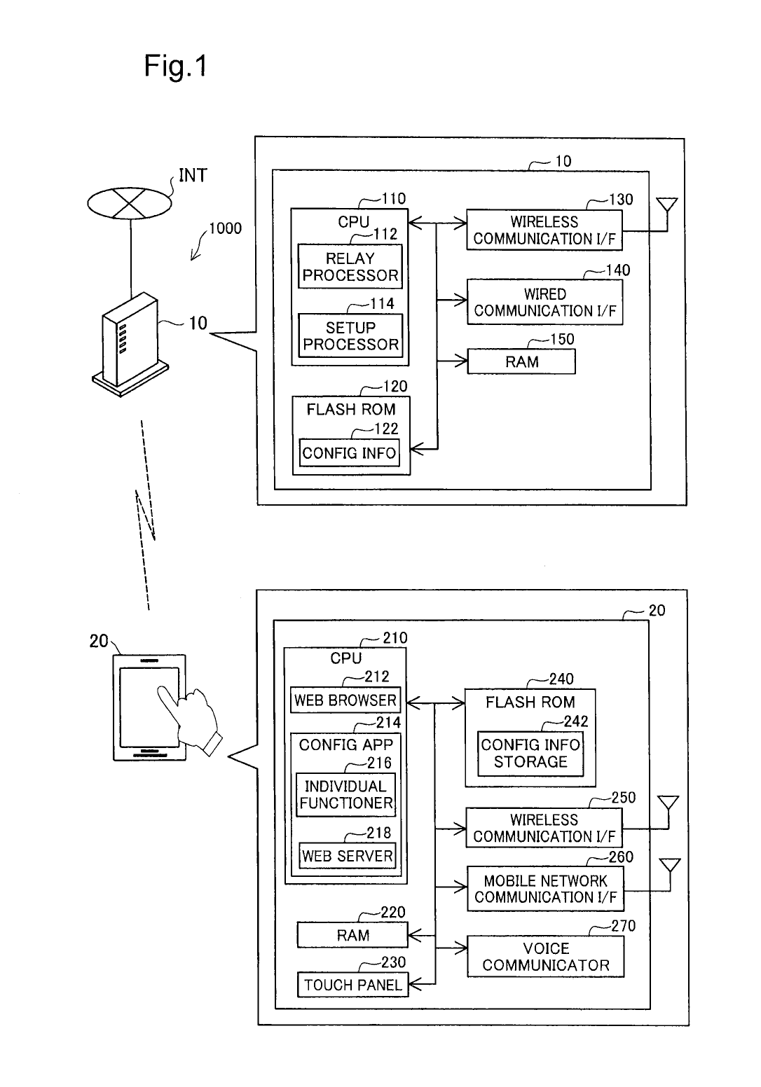

FIG. 1 is a diagram illustrating the general configuration of a network system using an information processing apparatus according to one embodiment of the disclosure. The network system 1000 includes a wireless network relay apparatus 10 and an information processing apparatus 20.

The wireless network relay apparatus 10 according to this embodiment is an access point device in conformity with IEEE 802.11. Hereinafter the wireless network relay apparatus 10 is also called “AP10”. The AP 10 also serves as a router and is connected to the Internet INT via a wired cable. The AP 10 is capable of relaying wireless communication of the information processing apparatus 20. The information processing apparatus 20 is connectable to the Internet INT via the AP 10. The AP 10 corresponds to the “external device” as used herein.

The information processing apparatus 20 of the embodiment is a personal digital assistance or mobile terminal including a wireless communication interface in conformity with IEEE 802. 11. Hereinafter the information processing apparatus 20 is also called “mobile terminal 20”. In the state of FIG. 1, the mobile terminal 20 has no settings of communication information and encryption information required for wireless communication with the AP 10 and has not yet established communication with the AP 10. The “communication information” herein means information required to establish communication, such as BSSID (Basic Service Set Identifier), ESSID (Extended Service Set Identifier) or SSID (Service Set Identifier). The “encryption information” includes information regarding a wireless LAN encryption system, such as WEP (Wired Equivalent Privacy), WPA (Wi-Fi Protected Access) or WPA2-PSK (Wi-Fi Protected Access 2 Pre-Shared Key) and a key used for encryption.

### A-2. General Structure of AP 10

The AP 10 includes processing circuitry including a CPU 110, a flash ROM 120, a wireless communication interface (I/F) 130, a wired communication interface (I/F) 140 and a RAM 150. The respective component parts of the AP 10 are interconnected by a bus. The term “processing circuitry”, as used herein may be located within one device, or distributed (e.g., more than process processor) amongst multiple devices.

The CPU 110 loads and executes a computer program, which is stored in at least one of the flash ROM 120 and a hard disk (not shown), onto the RAM 150 to control the AP 10. The CPU 110 implements the functions of a relay processor 112 and a setup processor 114.

The relay processor 112 performs a relay process that forwards a received packet according to its destination. The setup processor 114 implements the function that causes the communication information and the encryption information to be automatically set up in the mobile terminal 20. Typical examples of the function implemented by the setup processor 114 include generally known AOSS (AirStation One-Touch Secure System) and WPS (Wi-Fi Protected Setup). The setup processor 114 may implement any function that automatically sets up the communication information and the encryption information in the mobile terminal 20, for example, the improved function of AOSS.

The flash ROM 120 stores configuration information 122. The configuration information 122 of the AP 10 includes communication information and encryption information stored in advance. More specifically, the communication information is an SSID set in advance for the AP 10. When the AP 10 supports the multi SSID function, a plurality of SSIDs are stored in advance in the configuration information 122. The encryption information includes information regarding a wireless LAN encryption system available in the AP 10 and a key used for such encryption.

The wireless communication interface 130 includes a transmitting and receiving circuit (not shown). The wireless communication interface 130 serves to demodulate radio waves received via an antenna and generate data and also serves to generate and modulate radio waves that are to be transmitted via the antenna. The wired communication interface 140 is connected with a device that relays connection to the Internet INT connection and is connected with a device that is the opposite end of communication via a wired cable. The wired communication interface 140 includes a PHY/MAC (PHYsical layer/Medium Access Control layer) controller (not shown). The wired communication interface 140 serves to wave-shape a received signal and extract a MAC frame from the received signal.

### A-3. General Structure of Mobile Terminal 20

The mobile terminal 20 includes processing circuitry (in one device or distributed) including a CPU 210, a RAM 220, a touch panel 230, a flash ROM 240, a wireless communication interface (I/F) 250, a mobile network communication interface (I/F) 260 and a voice communicator 270. The respective component parts of the mobile terminal 20 are interconnected by a bus.

The CPU 210 loads and executes a computer program, which is stored in at least one of the flash ROM 240 and a hard disk (not shown), onto the RAM 220 to control the mobile terminal 20. The CPU 210 implements the functions of a WEB browser 212, a configuration application (config app) 214, an individual functioner 216 and a WEB server 218.

The WEB browser 212 is a computer program used to browse contents obtained from WWW (World Wide Web) according to a data transfer protocol, such as HTTP (HyperText Transfer Protocol). The data transfer protocol may be any client server-type protocol that enables information to be transmitted and received by using a loopback address in a communication protocol such as TCP/IP and may be, for example, HTTP, HTTPS (HyperText Transfer Protocol Secure) or FTP (File Transfer Protocol). These HTTP, HTTPS and FTP are, however, only illustrative and not restrictive. The WEB browser 212 also corresponds to “WEB page browser” as used herein.

The configuration application 214 is a computer program executed to make communication with the setup processor 114 of the AP 10 and set up the communication information and the encryption information in the mobile terminal 20 in a communication setup process described later. The configuration application 214 (executed in processing circuitry) includes the individual functioner 216 and the WEB server 218. The individual functioner 216 implements the function of communicating with the AP 10 described above and the function of setting up the communication information and the encryption information. The WEB server 218 implements “WEB server functions” that provide the WEB browser with HTML files and objects such as images according to the HTTP. The configuration application 214 corresponds to the “functioner” described herein. The individual functioner 216 as implemented in processing circuitry corresponds to the “individual functioner” described herein. The WEB server 218 corresponds to the “server functioner” as implemented in processing circuitry as described herein.

The WEB browser 212 is preinstalled in the flash ROM 240 of the mobile terminal 20. The configuration application 214 including the individual functioner 216 and the WEB server 218 is downloaded via communication between the mobile terminal 20 and the setup processor 114 of the AP 10 and is then installed in the mobile terminal 20. According to another embodiment, the configuration application 214 may be preinstalled in the flash ROM 240 of the mobile terminal 20.

The touch panel 20 detects at least one of a finger touch and a touch-pen (not shown) touch and outputs an electrical signal representing the touch position to the CPU 210. The touch panel 230 is colorless and transparent and is mounted over the image display surface of a display panel (not shown). When the user of the mobile terminal 20 finger-touches one of icons included in a GUI (Graphical User Interface) displayed on the image display surface of the display panel, the position of the touch panel 230 corresponding to the display position of the icon is pressed to enable the corresponding function of the mobile terminal 20.

The flash ROM 240 stores a computer program executed to control the mobile terminal 20. The flash ROM 240 includes a configuration information storage 242. The configuration information storage 242 is a storage for storing the communication information and the encryption information obtained by the configuration application 214.

The wireless communication interface 250 includes a transmitting and receiving circuit (not shown). The wireless communication interface 250 serves to demodulate radio waves received via an antenna and generate data and also serves to generate and modulate radio waves that are to be transmitted via the antenna. The mobile network communication interface 260 includes an antenna and a transmitting and receiving circuit (not shown). The mobile network communication interface 260 is operated to enable at least one of data communication and voice communication with a communication carrier by a mobile communication system in conformity with WiMAX/3G/LTE. According to another embodiment, the wireless communication interface 250 and the mobile network communication interface 260 may work in corporation with the CPU 210 to perform various series of processing.

The voice communicator 270 includes a speaker configured to output voice, a microphone configured to input voice and relevant circuits configured to drive the speaker and the microphone. The mobile terminal 20 is also operable as a telephone by cooperation of the mobile network communication interface 260 with the voice communicator 270.

### A-4. Communication Setup Process

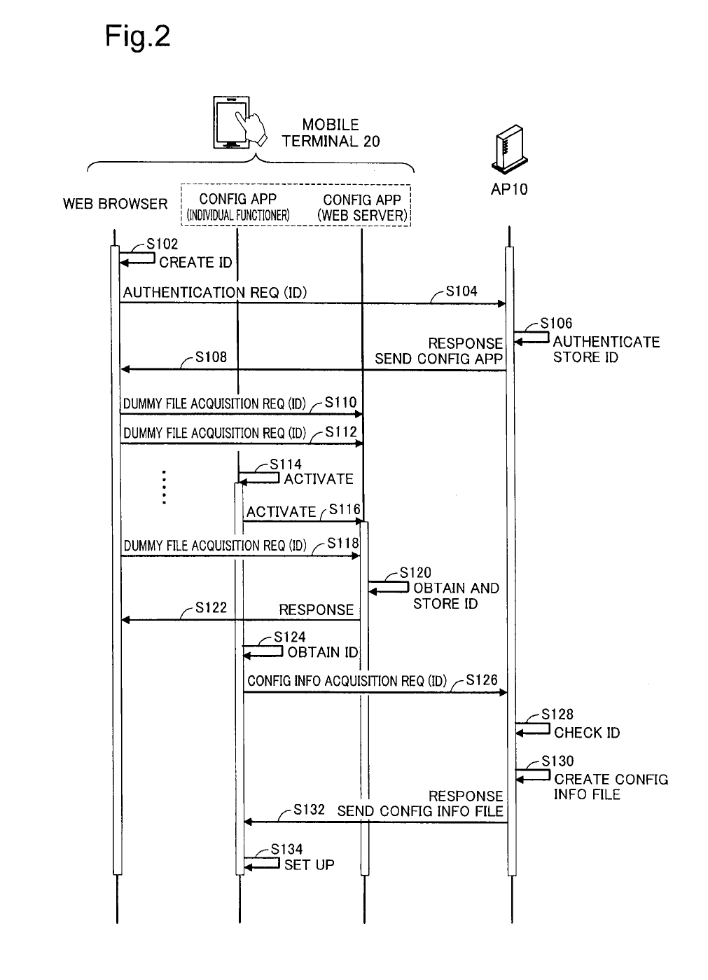

FIG. 2 is a sequence diagram showing the procedure of the communication setup process. According to the communication setup process, the mobile terminal 20 obtains the configuration information 122 from the setup processor 114 of the AP 10 and causes the communication information and the encryption information to be set up in the mobile terminal 20. The communication setup process is performed by the cooperation of the WEB browser 212 with the configuration application 214.

The WEB browser 212 of the mobile terminal 20 first creates an identifier used in the communication setup process (step S102). This identifier is also called “session ID” and is simply shown as “ID” in the drawing. The session ID is an arbitrarily set value but is not a fixed value and may be determined by random number generation. After creation of the session ID, the WEB browser 212 sends an authentication request to the AP 10 (step S104). More specifically, the WEB browser 212 sends the authentication request including an encrypted form of the session ID created at step S102, in addition to authentication information such as the user name and the password.

When receiving the authentication request, the setup processor 114 of the AP 10 authenticates the mobile terminal 20 by using the received authentication information (step S106). The setup processor 114 also stores the received session ID in the flash ROM 120. After the authentication, the setup processor 114 sends back the result of authentication to the mobile terminal 20 (step S108). When the result of authentication is “authorized”, the setup processor 114 sends the configuration application 214 together with the result of authentication to the mobile terminal 20.

When the result of authentication is “unauthorized”, on the other hand, the WEB browser 212 of the mobile terminal 20 retries the processing of step S104.

When the result of authentication is “authorized”, the WEB browser 212 of the mobile terminal 20 sends a dummy file acquisition request to the WEB server 218 of the configuration application 214, based on an HTML page received as the response from the AP 10 (step S110). The “dummy file acquisition request” is a request to obtain an arbitrary file on the WEB server. For example, the GET method of HTTP may be used for the dummy file acquisition request. The dummy file acquisition request is sent at step S110, for the purpose of transmission of the session ID from the WEB browser 212 to the WEB server. The file requested by the dummy file acquisition request may be any file such as an image file or a document file and determined arbitrarily. The WEB browser 212 adds the session ID created at step S102 to the query character string of the dummy file acquisition request. The following gives an example of the dummy file acquisition request:

<img src=http://127.0.0.1:XXXXX/XXX.png?ID=ABC″>

In the above example, the WEB browser 212 requests an image file with the name of “XXX.png”. Since the WEB browser 212 sends the request to the WEB server 218 of the same mobile terminal 20, the address of the request is the loopback address “127.0.0.1” representing its own self in this example. The character string following the colon of the loopback address represents the port number. In this example, the WEB browser 212 adds the session ID “ID=ABC” to the query character string.

At the time when the dummy file acquisition request is sent at step S110 in FIG. 2, the configuration application 214 received at step S108 and the WEB server 218 included in the configuration application 214 have not yet been activated. The request at step S110 is accordingly timed out to be failed. After step S110, the WEB browser 212 sends the same dummy file acquisition request as that sent at step S110 to the WEB server 218 at regular intervals (steps S112 and S118). The periodic transmission of the dummy file acquisition request continues until the WEB browser 212 receives a response from the WEB server 218. For convenience of illustration, the arrows representing the transmission of the dummy file acquisition request between steps S112 and S118 are omitted in FIG. 2. When the result of authentication is “authorized”, the WEB browser 212 of the mobile terminal 20 may perform various setup processes, which are to be executed by the WEB browser 212, for example, PPPoE connection settings for connection of the mobile terminal 20 to the WAN, at any timing before or after the transmission of the dummy file acquisition request.

In the mobile terminal 20 that receives the configuration application 214 from the AP 10, the configuration application 214 is activated (step S114). After activation of the configuration application 214, the individual functioner 216 in the configuration application 214 activates the WEB server 218 (step S116). The WEB server 218 is preferably configured to send back a response only to a request addressed to the loopback address. This arrangement advantageously prevents the session ID from being stolen by an external unauthorized access to the WEB server 218, thus improving the security. After being activated, the WEB server 218 in the configuration application 214 receives the dummy file acquisition request from the WEB browser 212 (step S118). The WEB server 218 obtains the session ID included in the query character string of the dummy file acquisition request and stores the obtained session ID in the RAM 220 (step S120). The WEB server 218 sends back a response including the file requested by the dummy file acquisition request to the WEB browser 212 (step S122).

The individual functioner 216 in the configuration application 214 obtains the session ID stored in the RAM 220 at step S120 (step S124). After obtaining the session ID, the individual functioner 216 sends a configuration information acquisition request to the AP 10 (step S126). More specifically, the individual functioner 216 sends the configuration information acquisition request including an encrypted form of the session ID obtained at step S124, in addition to performance information of the mobile terminals 20. The “performance information” includes information regarding the wireless availability level of the mobile terminal 20, for example, the model name of the wireless communication interface 250, and the encryption system supported by the wireless communication interface 250.

When receiving the configuration information acquisition request, the setup processor 114 of the AP 10 checks the session ID (step S128). For checking the session ID, the setup processor 114 compares the session ID received from the WEB browser of the mobile terminal 20 and stored in the flash ROM 120 at step S106 with the session ID received from the individual functioner 216 of the mobile terminal 20 at step S126 to identify matching or mismatching.

In the case of mismatching of the two session IDs, the setup processor 114 of the AP 10 identifies that the individual functioner 216 is invalid (for example, a program imitating the individual functioner created by a malicious third person) and terminates the processing.

In the case of matching of the two session IDs, on the other hand, the setup processor 114 of the AP 10 identifies that the individual functioner 216 is valid and creates a configuration information file (step S130). For creation of the configuration information file, the setup processor 114 selects information suitable for the mobile terminal 20 out of the communication information and the encryption information stored in the configuration information 122 of the flash ROM 120, based on the performance information of the mobile terminal 20 received at step S126 and creates the configuration information file that is to be transmitted. After creating the configuration information file, the setup processor 114 sends the created configuration information file to the individual functioner 216 (step S132).

After receiving the configuration information file, the individual functioner 216 of the mobile terminal 20 stores the contents of the received configuration information file in the configuration information storage 242 of the flash ROM 240 (step S134). The communication setup process is then terminated.

As described above, according to this embodiment, the setup processor 114 confirms the validity of the individual functioner 216 by comparing the session ID received from the WEB browser 212 of the mobile terminal 20 with the session ID received from the individual functioner 216 of the mobile terminal 20. The validity of the WEB browser 212 is guaranteed by the authentication at step S106.

According to the above procedure, the setup processor 114 checks the validity of the individual functioner 216, based on the determination of whether “two session IDs match or mismatch”. The setup process 114 may, however, adopt any other method that can confirm the validity by using both the session ID received from the WEB browser 212 and the session ID received from the individual functioner 216. For example, the setup processor 114 may check the validity, based on matching or mismatching of two hash values respectively converted by the hash function from the session ID received from the WEB browser 212 and the session ID received from the individual functioner 216. In another example, the setup processor 114 may identify that the individual functioner 216 is valid, when the session ID received from the WEB browser 212 and the session ID received from the individual functioner 216 follow a predetermined rule (even when the two session IDs are different values).

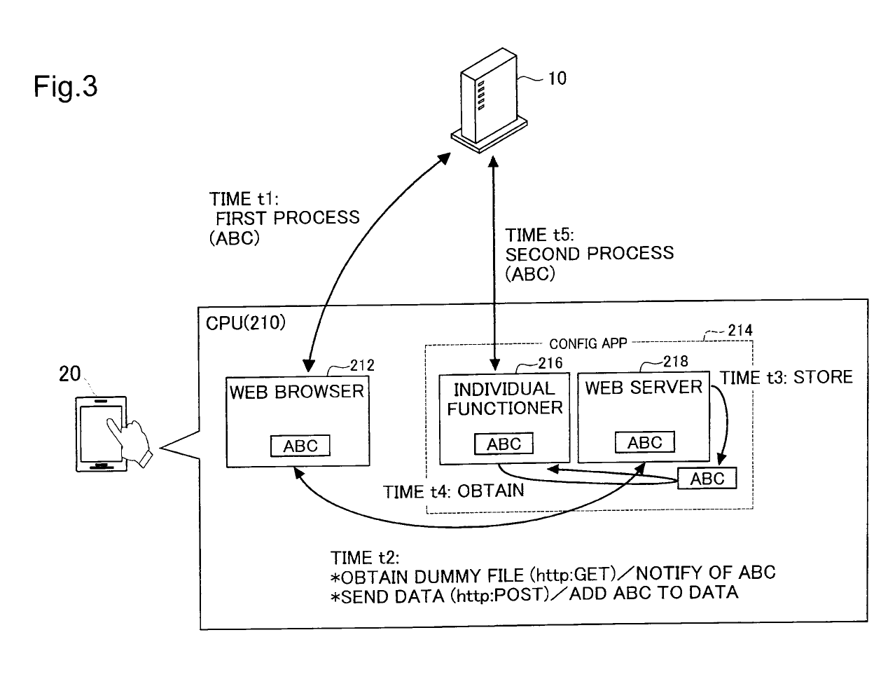

FIG. 3 is a diagram illustrating a data sharing method between the WEB browser 212 and the configuration application 214. FIG. 3 mainly shows the part relating to data sharing between the WEB browser 212 and the configuration application 214 in the communication setup process shown in FIG. 2.

In the course of the above process, at time t1, the WEB browser 212 of the mobile terminal 20 sends a request for first process to the AP 10. More specifically, the WEB browser 212 sends an identifier “ABC” together with the request for first process. After the AP 10 receives the request for first process, the first process is performed between the AP 10 and the mobile terminal 20. The “first process” herein is not specifically limited but may be any process that is performed between the WEB browser 212 and the AP 10. The first process in the illustrated example of FIG. 3 is equivalent to the authentication process of FIG. 2 (steps S104 and S106).

At time t2, the WEB browser 212 of the mobile terminal 20 makes connection with the WEB server 218 of the configuration application 214 and sends shared data that is to be shared between the WEB browser 212 and the configuration application 214. Either of the following two methods may be adopted to send the shared data.

(1) The first method adds the shared data to the query character string of the “dummy file acquisition request” described at step S110 of FIG. 2. In the illustrated example of FIG. 3, an identifier “ABC” is added to the query character string.

(2) The second method uses a “data transmission request”. The “data transmission request” is a request to send arbitrary data (for example, an image file, a text file or a binary file) to the WEB server. For example, the POST method of HTTP may be used for the data transmission request. The WEB browser 212 adds the shared data to transmission target data specified by the data transmission request. In the illustrated example of FIG. 3, the identifier “ABC” is added to the transmission target file specified by the data transmission request.

At time t3, the WEB server 218 of the mobile terminal 20 receives the shared data (identifier “ABC”) sent from the WEB browser 212 and stores the received shared data in the RAM 220.

At time t4, the individual functioner 216 of the mobile terminal 20 obtains the shared data (identifier “ABC”) stored in the RAM 220.

At time t5, the individual functioner 216 of the mobile terminal 20 sends a request for second process to the AP 10. More specifically, the individual functioner 216 sends the identifier “ABC” together with the request for second process. After receiving the request for second process, the AP 10 checks the validity of the configuration application 214 (individual functioner 216) by comparing the identifier received at the time t1 with the identifier received at the time t5 and determines whether execution of the second process is permitted or prohibited. The “second process” herein is not specifically limited but may be any process that is performed between the individual functioner 216 and the AP 10. The second process in the illustrated example of FIG. 3 is equivalent to transmission of the configuration information acquisition request (step S126), creation of the configuration information file (step S130) and transmission of the created configuration information file (step S132) of FIG. 2.

As described above, according to the first embodiment, the WEB browser 212 (WEB page browser) adds the shared data (session ID or identifier in the embodiment) to the file or the query character string, which is sent from the WEB browser 212 to the WEB server 218 (server functioner, WEB server) via the connection between the WEB browser 212 and the WEB server 218. This arrangement enables the shared data to be transferred from the WEB browser 212 to the individual functioner 216 of the configuration application 214 in the single mobile terminal 20 (information processing apparatus). Additionally, the communication for the transfer of the shared data is concluded within the mobile terminal 20 (between the WEB browser 212 and the configuration application 214), so that the shared data can be shared with no fear of external eavesdropping.

By the processes at the times t2 to t4 shown in FIG. 3, the mobile terminal 20 (information processing apparatus) can share the data required for cooperation of the individual functioner 216 included in the configuration application 214 (functioner) and the WEB browser 212 (WEB page browser).

According to the processes at the times t1 to t5 shown in FIG. 3, the WEB browser 212 (WEB page browser) of the mobile terminal 20 (information processing apparatus) creates an identifier as the shared data, sends the created identifier to the AP 10 (external device), and adds the created identifier to the file or query character string, which is sent from the WEB browser 212 to the WEB server 218 (server functioner, WEB server) via the connection between the WEB browser 212 and the WEB server 218. The individual functioner 216 of the mobile terminal 20 sends the identifier, which is obtained from the file or the query character string by the WEB server 218, to the AP 10. The AP 10 then checks the validity of the individual functioner 216 by using the identifier received from the WEB browser 212 and the identifier received from the individual functioner 216. The identifier sent by the WEB browser 212 and the identifier sent by the individual functioner 216 are the shared data shared between the WEB browser 212 and the individual functioner 216 by the processes at the times t2 to t4. The AP 10 can thus check the validity of the individual functioner 216 by means of, for example, comparing the identifier received from the WEB browser 212 with the identifier received from the individual functioner 216.

### B. Second Embodiment

A second embodiment of the disclosure describes the transfer of shared data from the configuration application to the WEB browser. The following describes only the structures and the operations different from those of the first embodiment. The component parts similar to those of the first embodiment are expressed by the like numerals or symbols and are not specifically described here.

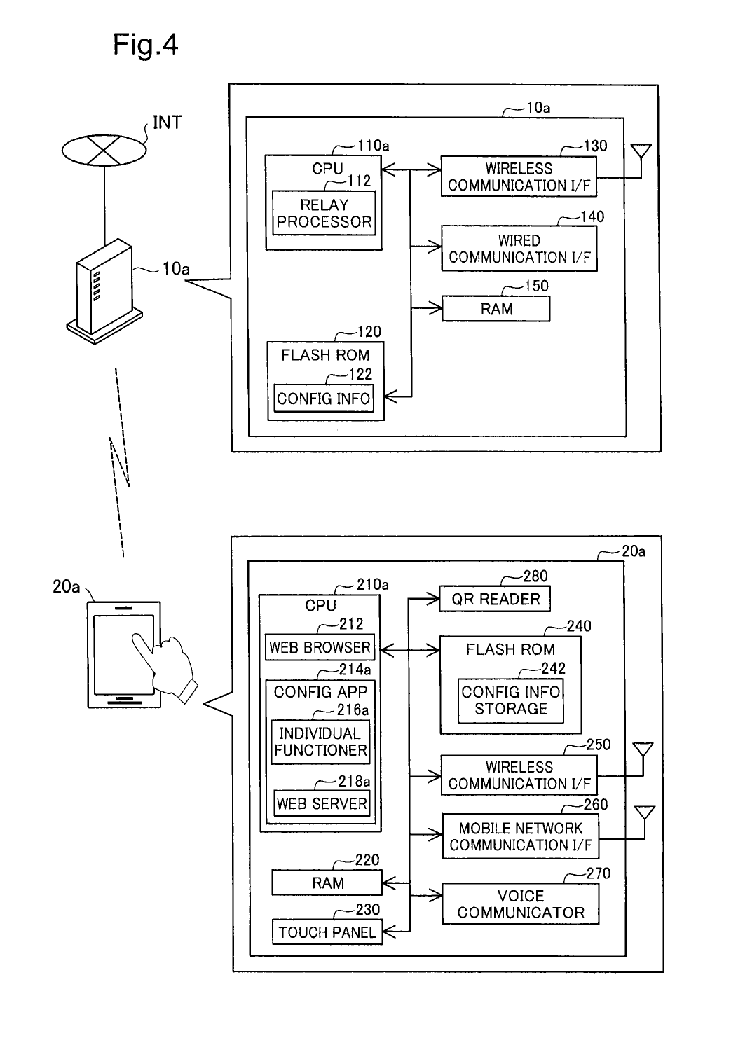

FIG. 4 is a diagram illustrating the general configuration of a network system using an information processing apparatus according to the second embodiment. The network system of the second embodiment is similar to the network system of the first embodiment, except replacement of the AP 10 with an AP 10a and replacement of the mobile terminal 20 with a mobile terminal 20a.

The AP 10a of the second embodiment is similar to the AP 10 of the first embodiment, except replacement of the CPU 110 with a CPU 110a. The CPU 110a of the second embodiment is similar to the CPU 110 of the first embodiment, except omission of the setup processor 114.

The mobile terminal 20a of the second embodiment is similar to the mobile terminal 20 of the first embodiment, except replacement of the CPU 210 with a CPU 210a and addition of a QR reader 280. The CPU 210a of the second embodiment is similar to the CPU 210 of the first embodiment, except replacement of the configuration application 214 with a configuration application 214a. The configuration application 214a has an individual functioner 216a and a WEB server 218a. Like the WEB server 218 of the first embodiment, the WEB server 218a of the second embodiment is preferably configured to send back a response only to a request addressed to the loopback address. The configuration application 214a of the second embodiment performs a different procedure of the communication setup process from that described in the first embodiment. The QR reader 280 reads, by the software configuration, the information contents included in a QR CODE® photographed with a camera (not shown).

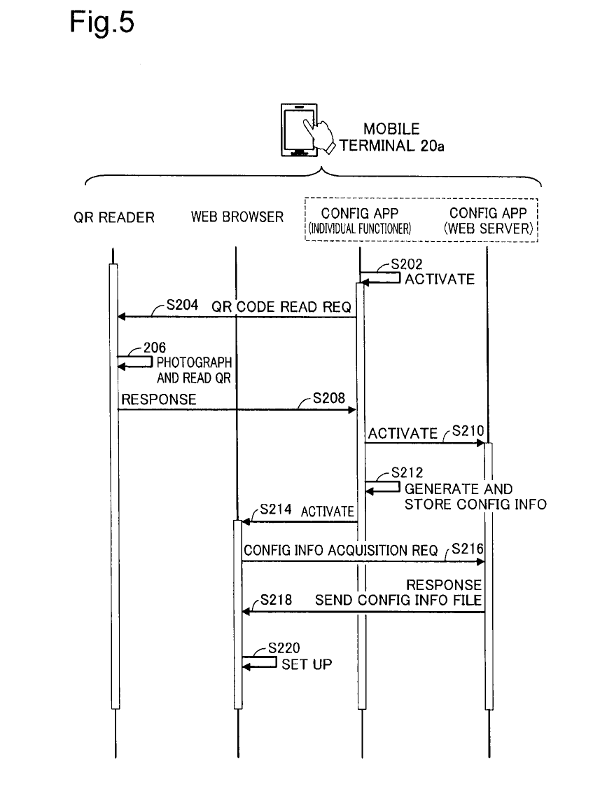

FIG. 5 is a sequence diagram showing the procedure of the communication setup process according to the second embodiment. According to the communication setup process of the second embodiment, the mobile terminal 20a reads a QR CODE included in the package of the AP 10a and sets up the communication information and the encryption information in the mobile terminal 20a via the WEB browser 212. The communication setup process is performed by the cooperation of the WEB browser 212 with the configuration application 214a.

The communication setup process of the second embodiment does not make communication with the AP 10a. The QR CODE included in the package of the AP 10a stores the information contents identical with the configuration information 122 of the AP 10 of the first embodiment.

The configuration application 214a preinstalled in the mobile terminal 20a is activated (step S202). The activation of the configuration application 214a may be automatic activation or may be manual activation by the operation of the user of the mobile terminal 20a. After activation of the configuration application 214a, the individual functioner 216a in the configuration application 214a sends a QR CODE read request to the QR reader 280 (step S204).

When receiving the QR CODE read request, the QR reader 280 analyzes the QR CODE photographed with a camera and reads the information contents (configuration information) stored in the QR CODE (step S206). After reading the configuration information from the QR CODE, the QR reader 280 sends the configuration information read from the QR CODE to the individual functioner 216a (step S208).

After receiving the configuration information, the individual functioner 216a of the configuration application 214a activates the WEB server 218a (step S210). The individual functioner 216a selects information suitable for the performance of the mobile terminal 20a (for example, wireless availability level and encryption system supported) out of the configuration information received at step S208 and creates a configuration information file for the mobile terminal 20a (step S212). The individual functioner 216a also stores the created configuration information file in the flash ROM 240. The individual functioner 216a then activates the WEB browser 212 (step S214).

After being activated, the WEB browser 212 sends a configuration information acquisition request to the WEB server 218a of the configuration application 214a, based on URL information transferred from the individual functioner 216a of the configuration application 214a at the time of activation (step S216). The “configuration information acquisition request” is a request to obtain a configuration information file on the WEB server. For example, the GET method of HTTP may be adopted for the configuration information acquisition request. The following gives an example of URL information transferred for transmission of the configuration information acquisition request.

http://127.0.0.1:XXXXX/XXX.inf

In the above example, the WEB browser 212 requests a configuration information file with the name of “XXX.inf”. The WEB browser 212 sets the loopback address as the address of this request in this example, like the first embodiment. The character string following the colon of the loopback address represents the port number.

After receiving the configuration information acquisition request, the WEB server 218a sends the configuration information file created and stored in the flash ROM 240 at step S212 to the WEB browser 212 (step S218). After receiving the configuration information file, the WEB browser 212 stores the contents of the configuration information file received from the WEB server 218a in the configuration information storage 242 of the flash ROM 240 (step S220). The communication setup process is then terminated.

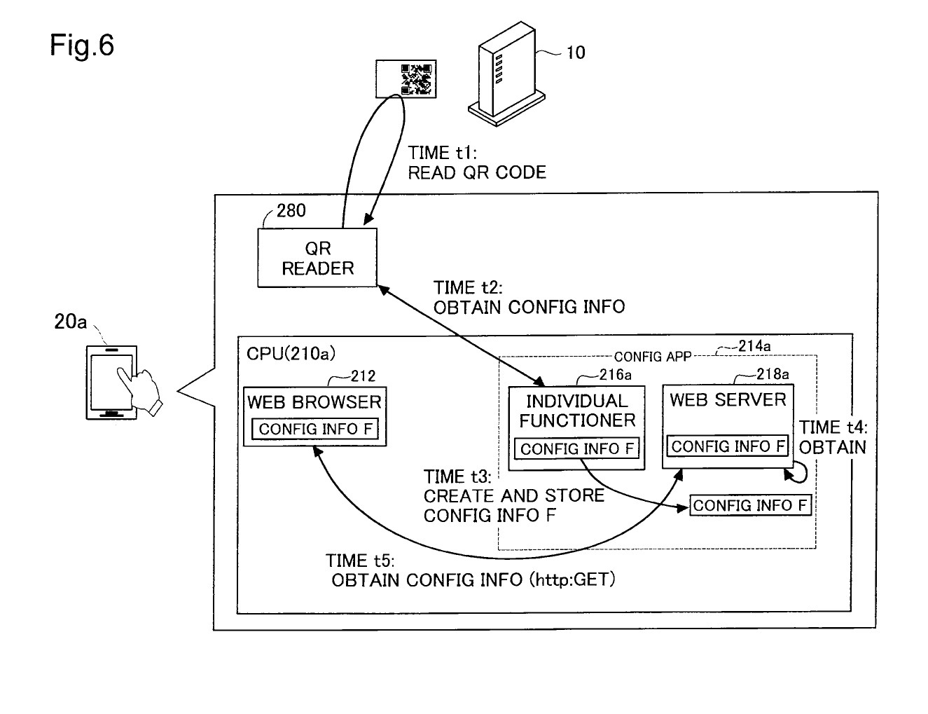

FIG. 6 is a diagram illustrating a data sharing method between the WEB browser 212 and the configuration application 214a according to the second embodiment. FIG. 6 mainly shows the part relating to data sharing between the WEB browser 212 and the configuration application 214a in the communication setup process shown in FIG. 5.

In the course of the above process, at time t1, the QR reader 280 of the mobile terminal 20a reads the configuration information stored in the QR CODE. At time t2, the individual functioner 216a of the configuration application 214a obtains the configuration information read by the QR reader 280. At time t3, the individual functioner 216a creates a configuration information file for the mobile terminal 20a (shown as “config info F” in the drawing) from the obtained configuration information and stores the created configuration information file in the flash ROM 240. At time t4, the WEB server 218a of the configuration application 214a obtains the configuration information file stored in the flash ROM 240. At time t5, the WEB browser 212 makes connection with the WEB server 218a of the configuration application 214a and sends a request for transmission of shared data (configuration information for the mobile terminal 20a) that is to be shared between the WEB browser 212 and the configuration application 214a. As a response to this request, the configuration information file including the shared data (configuration information for the mobile terminal 20a) is sent from the WEB server 218a to the WEB browser 212.

As described above, according to the second embodiment, the WEB server 218a (server functioner, WEB server) adds the shared data (configuration information for the mobile terminal 20a in the embodiment) to the file that is sent from the WEB server 218a to the WEB browser 212 (WEB page browser) via the connection between the WEB browser 212 and the WEB server 218a. This arrangement enables the shared data to be transferred from the configuration application 214a (functioner) to the WEB browser 212 within the single mobile terminal 20a (information processing apparatus).

The first embodiment describes the method of transferring the shared data from the WEB browser (WEB page browser) to the configuration application (functioner), whereas the second embodiment describes the method of transferring the shared data from the configuration application to the WEB browser. The method described in the first embodiment and the method described in the second embodiment may be used in combination for some purposes. This enables data to be shared between the WEB browser and the configuration application within the single mobile terminal (information processing apparatus), for the purpose of management of information involved in a plurality of different processes performed between the WEB browser and the configuration application.

### C. Third Embodiment

A third embodiment of the disclosure describes a variation of the “first process” and the “second process” of the first embodiment (FIG. 3). The following describes only the structures and the operations different from those of the first embodiment. The component parts similar to those of the first embodiment are expressed by the like numerals or symbols and are not specifically described here.

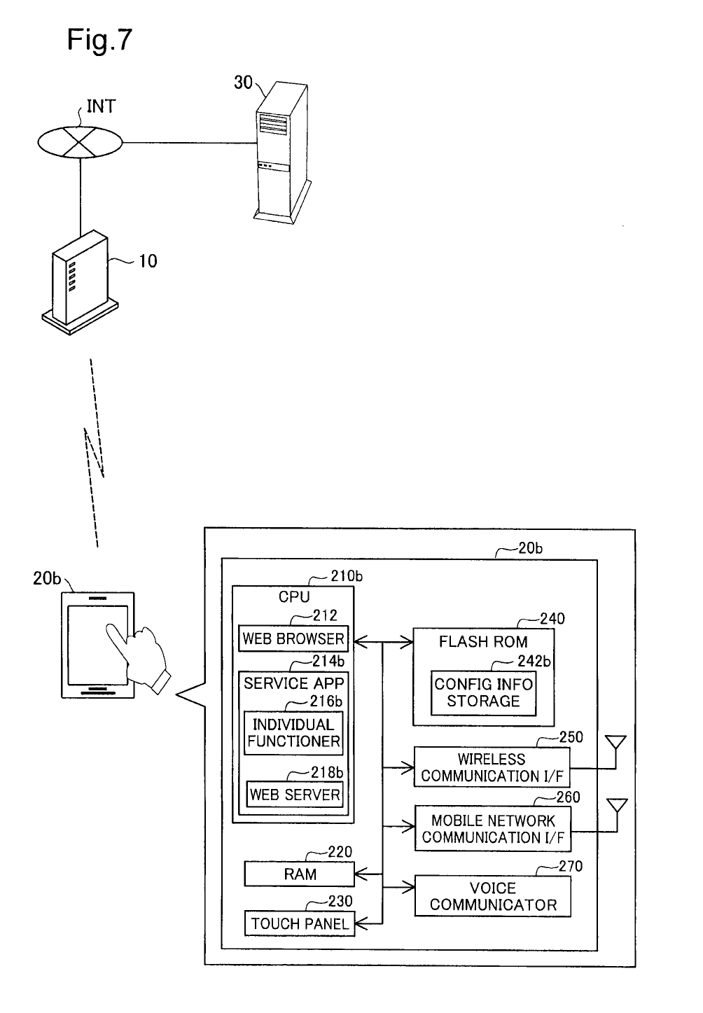

FIG. 7 is a diagram illustrating the general configuration of a network system using an information processing apparatus according to the third embodiment. The network system of the third embodiment is similar to the network system of the first embodiment, except replacement of the mobile terminal 20 with a mobile terminal 20b and connection of a server 30 to the Internet INT. The server 30 is a server that provides predetermined services. The services provided by the server 30 may be, for example, SNS services, storage services such as DROP BOX®, bulletin board services, auction services and online shop services.

The mobile terminal 20b of the third embodiment is similar to the mobile terminal 20 of the first embodiment, except replacement of the configuration information storage 242 with a configuration information storage 242b and replacement of the CPU 210 with a CPU 210b. The configuration information storage 242b has the settings of the communication information and the encryption information for communication between the mobile terminal 20b and the AP 10. The CPU 210b of the third embodiment is similar to the CPU 210 of the first embodiment, except replacement of the configuration application 214 with a service application (service app) 214b. The service application 214b includes an individual functioner 216b and a WEB server 218b. The service application 214b is an application executed to use the services provided by the server 30. The service application 214b is downloaded via the communication established between the mobile terminal 20b and the server 30. According to another embodiment, the service application 214b may be preinstalled in the flash ROM 240 of the mobile terminal 20b.

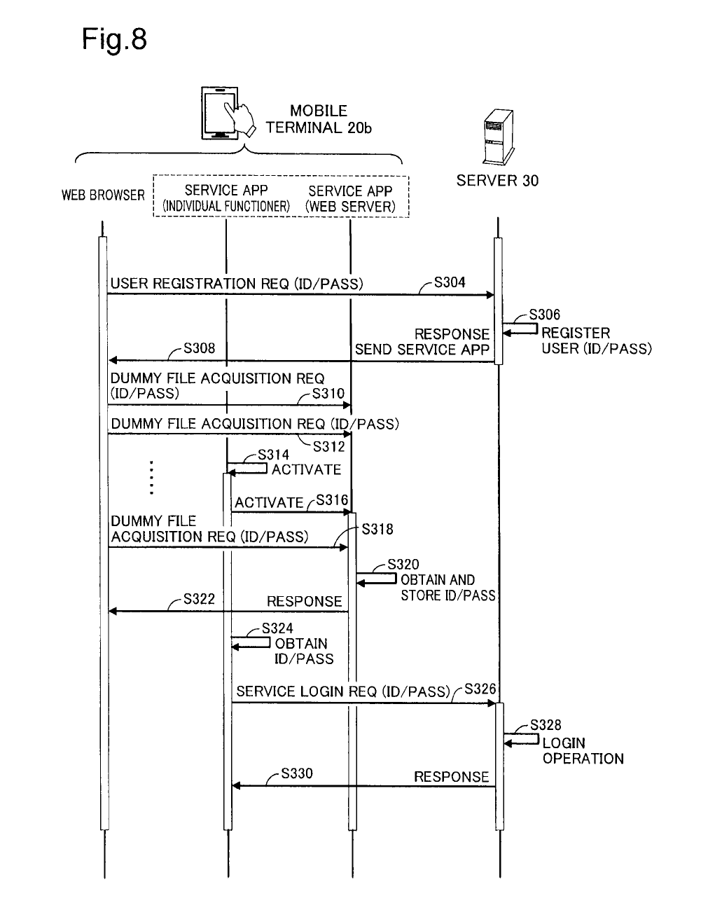

FIG. 8 is a sequence diagram showing the procedure of a service starting process. The service starting process is performed by the cooperation of the WEB browser 212 and the service application 214b.

The WEB browser 212 of the mobile terminal 20b first sends a user registration request to the server 30 (step S304). More specifically, the WEB browser 212 sends the user registration request together with a user ID and a password specified by a user. In FIG. 8, for convenience of illustration, the user ID and the passwords are respectively shown as “ID” and “PASS”.

When receiving the user registration request, the server 30 stores the user ID and the password received from the WEB browser 212 into a ROM (not shown) (step S306). After storing the user ID and the password, the server 30 sends back a notification of user registration and the service application 214b to the mobile terminal 20b (step S308). According to another embodiment, when the service application 214b is preinstalled in the mobile terminal 20b, the server 30 sends back only the notification of user registration.

After receiving the response from the server 30, the WEB browser 212 of the mobile terminal 20b sends a dummy file acquisition request, which is similar to that of the first embodiment, to the WEB server 218b of the service application 214b, based on an HTML page received as the response from the server 30 (step S310). The WEB browser 212 adds the user ID and the password specified at step S304 to the query character string of the dummy file acquisition request.

At the time when the dummy file acquisition request is sent at step S310 in FIG. 8, the service application 214b received at step S308 and the WEB server 218b included in the service application 214b have not yet been activated. The request at step S310 is accordingly timed out to be failed. After step S310, the WEB browser 212 sends the same dummy file acquisition request as that sent at step S310 at regular intervals (steps S312 and S318), like the periodic transmission after step S110 of first embodiment.

In the mobile terminal 20b that receives the service application 214b from the server 30, the service application 214b is activated (step S314). After activation of the service application 214b, the individual functioner 216b in the service application 214b activates the WEB server 218b (step S316). The WEB server 218b in the service application 214b receives the dummy file acquisition request from the WEB browser 212 (step S318). The WEB server 218b then obtains the user ID and the password included in the query character string of the dummy file acquisition request and stores the user ID and the password in the flash ROM 240 (step S320). The WEB server 218b sends back a response including the file requested by the dummy file acquisition request to the WEB browser 212 (step S322).

The individual functioner 216b in the service application 214b obtains the user ID and the password stored in the RAM 220 at step S320 (step S324). After obtaining the user ID and the password, the individual functioner 216b sends a service login request to the server 30 (step S326). More specifically, the individual functioner 216b sends the user ID and the password obtained at step S324, together with the service login request.

When receiving the service login request, the server 30 checks the user ID and the password like step S128 of the first embodiment and performs a login operation (step S328). In the case of matching the user ID and the password, the server 30 sends information for displaying a screen after login to the individual functioner 216b of the service application 214b (step S330).

The user of the mobile terminal 20b can automatically log in the services using an exclusive application (service application 214b) by simply sending a request for user registration via the WEB browser 212. This arrangement improves the convenience of the services using the information processing apparatus.

As described above, the method of sharing data between the WEB browser (WEB page browser) and the predetermined function program (functioner) described in the first embodiment is applicable to various services performed by the cooperation of the WEB browser and the function program. Although the description is omitted in the third embodiment, the method of sharing data described in the second embodiment is also applicable to various services.

### D. Fourth Embodiment

A fourth embodiment of the disclosure describes the configuration that implements the similar functions to those of the first embodiment by using FTP in place of HTTP. The following describes only the structures and the operations different from those of the first embodiment. The component parts similar to those of the first embodiment are expressed by the like numerals or symbols and are not specifically described here.

D-1. General Configuration of System

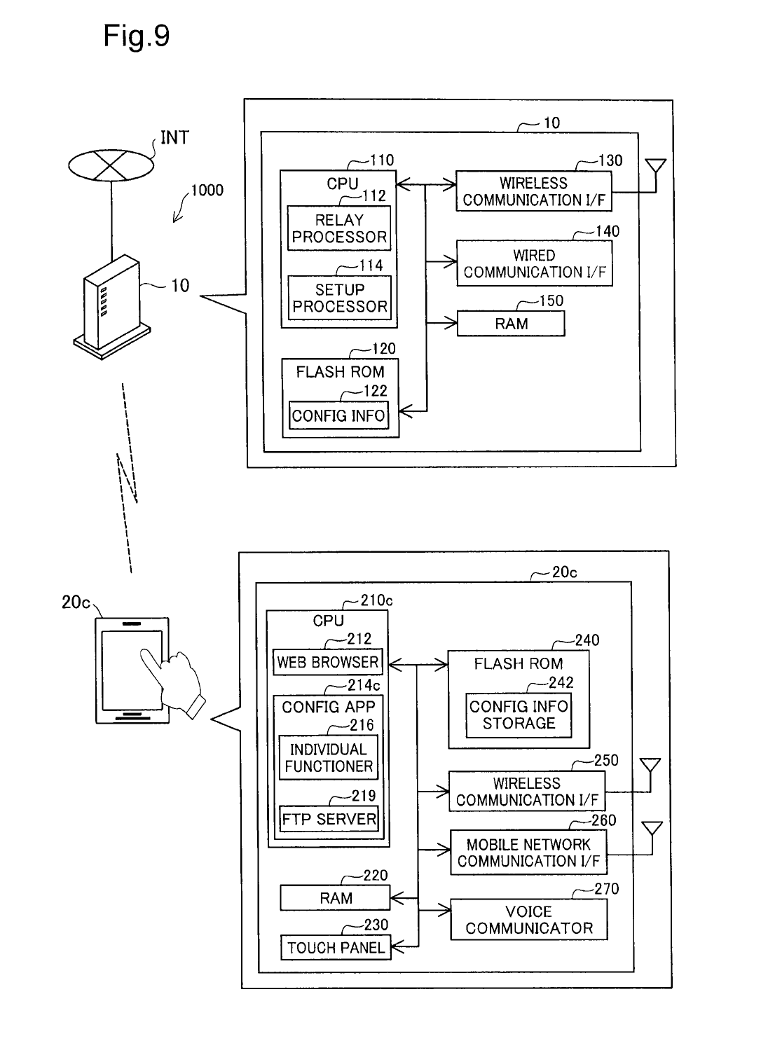

FIG. 9 is a diagram illustrating the general configuration of a network system using an information processing apparatus according to the fourth embodiment. The difference from the first embodiment shown in FIG. 1 is replacement of the mobile terminal 20 with a mobile terminal 20c.

D-2. General Structure of AP 10

The structure of the AP 10 is similar to that of the first embodiment shown in FIG. 1.

D-3. General Structure of Mobile Terminal 20c

The mobile terminal 20c has a CPU 210c, in place of the CPU 210. The CPU 210c includes a configuration application 214c, in place of the configuration application 214. The configuration application 214c includes an FTP server 219, in place of the WEB server 218. The FTP server 219 implements “FTP server functions” that send and receive a file to and from the WEB browser according to the FTP. The FTP server 219 as implanted in processing circuitry of the embodiment corresponds to “server functioner” as used herein.

D-4. Communication Setup Process

Like the first embodiment, according to the communication setup process of the fourth embodiment, the mobile terminal 20c obtains the configuration information 122 from the setup processor 114 of the AP 10 and causes the communication information and the encryption information to be set up in the mobile terminal 20c. The communication setup process of the embodiment is performed by the cooperation of the WEB browser 212 and the configuration application 214c. The procedure of the communication setup process of the fourth embodiment is similar to that of the first embodiment described in FIGS. 2 and 3, except the following differences. In the following description, the mobile terminal 20, the configuration application 214 and the WEB server 218 in FIGS. 2 and 3 are replaced respectively with the mobile terminal 20c, the configuration application 214c and the FTP server 219.

At step S110, the WEB browser 212 of the mobile terminal 20c sends a dummy file acquisition request to the FTP server 219 of the configuration application 214c, based on an HTML page received as the response from the AP 10. The “dummy file acquisition request” of this embodiment is a request to obtain an arbitrary file on the FTP server. The dummy file acquisition request is sent at step S110, for the purpose of transmission of the session ID from the WEB browser 212 to the FTP server. The file requested by the dummy file acquisition request may thus be determined arbitrarily. The WEB browser 212 adds the session ID created at step S102 to the dummy file acquisition request. The following gives an example of the dummy file acquisition request:

ftp://127.0.0.1:XXXXX/ABC/dummy.jpg

In the above example, the WEB browser 212 requests an image file with the name of “dummy.jpg”. Since the WEB browser 212 sends the request to the FTP server 219 of the same mobile terminal 20c, the address of the request is the loopback address representing its own self in this example. The character string following the colon of the loopback address represents the port number. In this example, the WEB browser 212 adds the session ID “ABC” as the directory name of the requested file. The session ID is not limited to the directory name but is included in the file path of the requested file.

At step S120, the FTP server 219 obtains the session ID included in the file path of the dummy file acquisition request and stores the obtained session ID in the RAM 220.

As described above, according to the fourth embodiment, the WEB browser 212 (Web page browser) adds the shared data (session ID or identifier) to the file that is sent from the WEB browser 212 to the FTP server 219 (server functioner) via the connection between the WEB browser 212 and the FTP server 219, or the file path of the file. This arrangement enables the shared data to be transferred from the WEB browser 212 to the individual functioner 216 of the configuration application 214c within the single mobile terminal 20c (information processing apparatus). As a result, this ensures the similar advantageous effects to those of the first embodiment.

### E. Fifth Embodiment

A fifth embodiment of the disclosure describes the configuration that implements the similar functions to those of the second embodiment by using FTP in place of HTTP. The following describes only the structures and the operations different from those of the second embodiment. The component parts similar to those of the second embodiment are expressed by the like numerals or symbols and are not specifically described here.

E-1. General Configuration of System

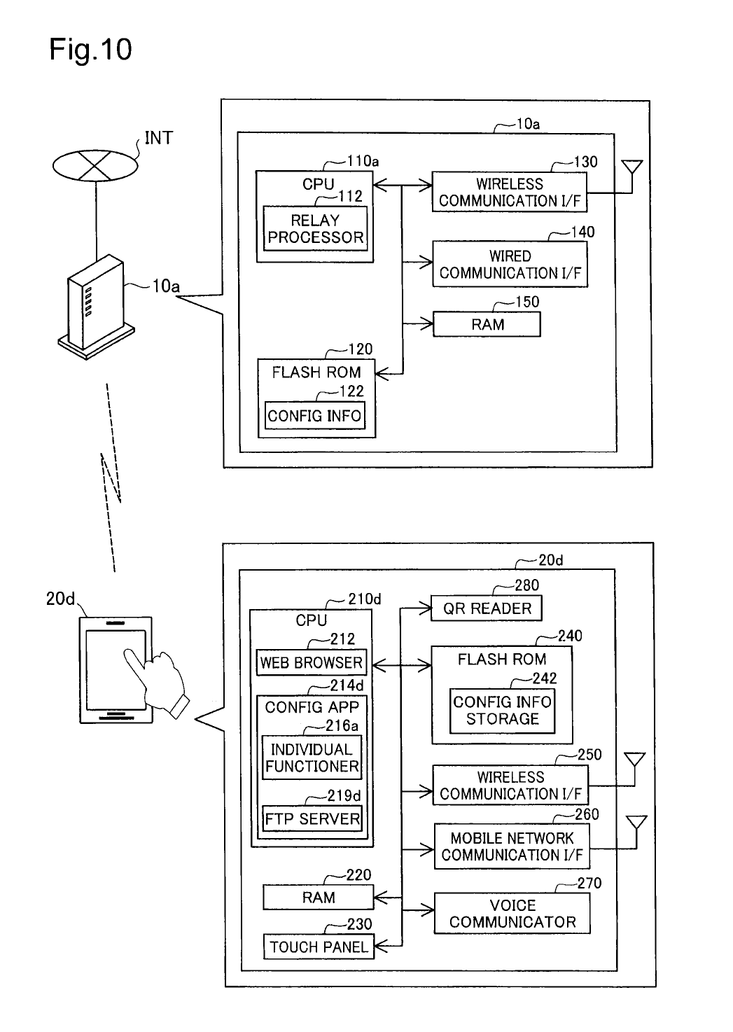

FIG. 10 is a diagram illustrating the general configuration of a network system using an information processing apparatus according to the fifth embodiment. The difference from the second embodiment shown in FIG. 4 is replacement of the mobile terminal 20a with a mobile terminal 20d.

E-2. General Structure of AP 10

The structure of the AP 10a is similar to that of the second embodiment shown in FIG. 4.

E-3. General Structure of Mobile Terminal 20c

The mobile terminal 20d has a CPU 210d, in place of the CPU 210a. The CPU 210d includes a configuration application 214d, in place of the configuration application 214a. The configuration application 214d includes an FTP server 219d, in place of the WEB server 218a.

E-4. Communication Setup Process

Like the second embodiment, according to the communication setup process of the fifth embodiment, the mobile terminal 20d reads the QR CODE included in the package of the AP 10a and sets up the communication information and the encryption information in the mobile terminal 20d itself via the WEB browser 212. The communication setup process of this embodiment is performed by the cooperation of the WEB browser 212 and the configuration application 214d. The procedure of the communication setup process of the fifth embodiment is similar to that of the second embodiment described in FIGS. 5 and 6, except the following differences. In the following description, the mobile terminal 20a, the configuration application 214a and the WEB server 218a in FIGS. 5 and 6 are replaced respectively with the mobile terminal 20d, the configuration application 214d and the FTP server 219d.

At step S216, the activated WEB browser 212 sends a configuration information acquisition request to the FTP server 219d of the configuration application 214d, based on URL information transferred from the individual functioner 216a of the configuration application 214d at the time of activation. The “configuration information acquisition request” of the embodiment is a request to obtain any configuration information file on the FTP server and is created in the format conforming to the FTP protocol.

As described above, according to the fifth embodiment, the FTP server 219d (server functioner) adds the shared data to the file that is sent from the FTP server 219d to the WEB browser 212 (WEB page browser) via the connection between the WEB browser 212 and the FTP server 219d. This arrangement enables the shared data to be transferred from the configuration application 214d (functioner) to the WEB browser 212 within the single mobile terminal 20d (information processing apparatus). As a result, this ensures the similar advantageous effects to those of the second embodiment.

The similar functions to those of the third embodiment can also be implemented by using FTP in place of HTTP.

### F. Modifications

In any of the embodiments described above, part of the hardware configuration may be replaced by the software configuration, and part of the software configuration may be replaced by the hardware configuration. Some examples of possible modifications are given below.

### Modification 1:

The above embodiments describe the configurations of the network system and the structures of the mobile terminal, the AP and the server included in the network system. The configuration of the network system and the structures of the respective apparatuses described in the above embodiments are, however, only illustrative, and any other configurations and structures may be adopted. For example, part of the configuration components may be omitted, different configuration components may be added, or part of the configuration components may be changed or modified.

For example, the above embodiments describe the mobile terminal as one example of the information processing apparatus that enables data sharing between the WEB browser (WEB page browser) and the predetermined function program (functioner). The information processing apparatus that enables data sharing between the WEB browser and the predetermined function program may, however, be any of various other apparatuses and devices including network relay apparatuses, servers, personal computers, PDA (personal digital assistants), game machines, audio players, printers and TV sets.

For example, the mobile terminal of the above embodiment includes the touch panel having both the functions of the display unit and the operation unit. The mobile terminal may, however, be equipped with a display as the display unit and input buttons as the operation unit, in place of the touch panel.

In the above embodiments, the configuration information is stored in the flash ROMs of the AP and the mobile terminal. The configuration information may, however, be stored in a storage medium other than the flash ROM. For example, the AP and the mobile terminal may have USB (Universal Serial Bus) interfaces, and the configuration information may be stored in a detachable storage medium, such as USB memory.

### Modification 2:

The above embodiments (FIGS. 2 and 5) describe the exemplary procedures of the communication setup process. These procedures of the above embodiments are, however, only illustrative and may be modified in various ways. Part of the steps may be omitted, different steps may be added, or the execution order of the steps may be changed.

For example, according to the first embodiment (FIG. 2) described above, the mobile terminal downloads the configuration application from the AP at step S108. The configuration application may, however, be preinstalled in the mobile terminal. According to another modification, the mobile terminal may obtain the configuration application from a detachable storage medium, such as DVD or USB memory.

According to the second embodiment (FIG. 5) described above, the QR reader of the mobile terminal reads the configuration information stored in the QR CODE in the communication setup process. The QR CODE is, however, only one example, and the configuration information may be provided by any of various methods, for example, one-dimensional barcode, two-dimensional barcode other than QR CODE or RFID (Radio Frequency IDentification).

According to the second embodiment (FIG. 5) described above, the QR CODE is provided in the form included in the package. The method of providing the QR CODE is, however, modified or changed in various ways; for example, the QR CODE may be provided in the form marked in the AP itself or may be provided in the form shown in a display in the AP that is equipped with the display. According to another modification, another terminal connected with the AP may establish communication with the AP to obtain the configuration information, encode the obtained configuration information into a QR CODE and output the QR CODE to the display or the printer of the terminal.

What is claimed is:

1. An information processing apparatus, comprising:
processing circuitry configured to implement
a WEB page browser configured to serve as a WEB browser,
an individual functioner configured to process information, and
a server functioner configured to cause shared data to be transferred to and from the WEB page browser according to a data transfer protocol, wherein
the WEB page browser and the individual functioner are configured to share the shared data therebetween.

2. The information processing apparatus according to claim 1, wherein
the WEB page browser makes a connection with the server functioner, and
at least one of the server functioner and the WEB page browser adds the shared data to information that is sent and received via the connection.

3. The information processing apparatus according to claim 1, wherein
the server functioner receives at least one of a file and a query character string including the shared data from the WEB page browser according to the data transfer protocol, so as to obtain the shared data.

4. The information processing apparatus according to claim 1, wherein
the shared data is data required for cooperation of the individual functioner with the WEB page browser.

5. The information processing apparatus according to claim 1, wherein
the server functioner sends a file including the shared data to the WEB page browser according to the data transfer protocol, so as to provide the shared data.

6. The information processing apparatus of claim 1, wherein
the data transfer protocol is one of HTTP, HTTPS and FTP.

7. The information processing apparatus of claim 1, further comprising:
a camera; and
a QR reader that converts an image of a QR CODE captured by the camera into information that is included in the shared data.

8. A network system, comprising:
an information processing apparatus, having
processing circuitry configured to implement
a WEB page browser configured to serve as a WEB browser,
an individual functioner configured to process information, and
a server functioner configured to cause shared data to be transferred to and from the WEB page browser according to a data transfer protocol, wherein
the WEB page browser and the individual functioner are configured to share the shared data therebetween and the server functioner receives at least one of a file and a query character string including the shared data from the WEB page browser according to the data transfer protocol, so as to obtain the shared data; and
an external device configured to be connectable with the information processing apparatus via a network wherein
the WEB page browser creates an identifier used to make communication settings with the external device as the shared data, sends the created identifier to the external device, and adds the identifier to at least one of a file and a query character string that is to be sent to the server functioner,
the server functioner receives at least one of the file and the query character string including the added identifier from the WEB page browser, so as to obtain the identifier,
the individual functioner sends the identifier obtained by the server functioner to the external device, and
the external device checks validity of the individual functioner by using the identifier received from the WEB page browser and the identifier received from the individual functioner.

9. A method of performing a process between an individual functioner configured to process information and a WEB page browser within a single device, the method comprising:
(a) causing with processing circuitry shared data to be transmitted between the WEB page browser and the individual functioner according to a data transfer protocol, wherein the shared data is shared between the WEB page browser and the individual functioner.

10. The method according to claim 9, wherein the (a) causing includes
(a1) causing the WEB page browser to connect with the server functioner; and
(a2) causing at least one of the server functioner and the WEB page browser to add the shared data to information that is sent and received via the connection.

11. The method according to claim 10, wherein
the (a2) causing includes causing the server functioner to receive at least one of a file and a query character string including the shared data from the WEB page browser according to the data transfer protocol, so as to obtain the shared data.

12. The method according to claim 10, wherein
the (a2) causing includes causing the server functioner to send a file including the shared data to the WEB page browser according to the data transfer protocol, so as to provide the shared data.

13. A network system, comprising:
an information processing apparatus including a WEB page browser; and
an external device having processing circuitry configured to cause a computer program to be downloaded to the information processing apparatus via a network, wherein
the computer program when executed by the processing circuitry causes the information processing apparatus to implement
an individual function that processes information, and
a server function that causes shared data to be transmitted to and from the WEB page browser according to a data transfer protocol, wherein the WEB page browser and the individual function are configured to share the shared data therebetween.

14. A non-transitory, computer-readable storage medium that stores a computer program that causes processing circuitry in an information processing apparatus including a WEB page browser to have a function different from the WEB page browser, wherein
the computer program when executed by the processing circuitry causes the information processing apparatus to implement
an individual function that processes information; and
a server function that causes shared data to be transmitted to and from the WEB page browser according to a data transfer protocol, wherein the WEB page browser and the individual function are configured to share the shared data therebetween.
